(19) United States
(12) Patent Application Publication
(10) Pub. No.: US 2007/0104857 A1
(43) Pub. Date: May 10, 2007

(54) METHOD OF OBTAINING FOOD ARTICLE TYPE STROGANOFF IN BAG-TYPE FLEXIBLE PACKING FOR IMMEDIATE CONSUMPTION STABLE AT ENVIRONMENT TEMPERATURE

(76) Inventor: Jose Barbosa Machado Neto, Itupeva (BR)

Correspondence Address: NOTARO AND MICHALOS, 100 DUTCH HILL ROAD, SUITE 110, ORANGEBURG, NY, 10962-2100, US

(21) Appl. No.: 11/552,899

(22) Filed: Oct. 25, 2006

(30) Foreign Application Priority Data
Oct. 31, 2005 (BR) PI0505194-0

(51) Int. Cl. A23L 1/31

(52) U.S. Cl. 426/646

(57) ABSTRACT

“Obtaining method of a food article-type—Stroganoff—in a flexible bag-type or similar packing, for immediate consumption stable at environment temperature”, obtaining method that dispenses with refrigeration for the conservation of the “Stroganoff”-type product ready for consumption during the whole chain formed from industrial production to the preparation/consumption by the final consumer, that is, consisting of stages that, after the product is packed, it dispenses with refrigeration during transport, storage and/or exhibition for sale, naturally maintaining all the product features and qualities of the ready product without the need of a cold chain (cooling and/or freezing) for such; the present manufacturing method can be applied to several other different types of sauces which are commonly found for sale under refrigeration.

### TECHNICAL FIELD

The present invention deals with a method of obtaining a “stroganoff” food article in a flexible bag- or pouch-type packing, for immediate consumption, stable at environment temperatures, not requiring in this way refrigeration means for its conservation, transport, storage and/or sales exhibition. The method deals more particularly with “Stroganoff” food product conservation process, which naturally maintains all its features and quality without the need of a refrigeration chain (cooling and freezing) for such, due to the form of preparation and the packing to which it is conditioned; the present method of manufacturing can be applied to several other types of different food products containing meats and furnishings which are today usually found for sale under refrigerated storage.

### FOUNDATIONS OF THE TECHNIQUE

Consumers today do not have, due to requirements of their work, studies and other occupational obligations much time to cook, and thus prefer to acquire “ready dishes” of easy manipulation and which contain their basic nutritional features. It is also known, especially by manufacturers and producers, that one of the basic consumer requirements is that “ready dishes”, after their preparation (heated in microwave or common ovens) by the consumer, should have a flavor close to or similar to the dishes that the consumers themselves prepare at home, without the so-called “industrial flavor”.

Now worried with the growing ready-dish market, manufacturers seek to ally practicality to nutritional quality in the same product, guaranteeing mostly their factors of conservation, from manufacturing until they reach consumer hands.

As is widely known, both by consumers and manufacturers of food products of the “Stroganoff” type, due to the fact that they contain bovine, poultry or fish meat in their formulation, refrigeration (cooling and/or freezing) becomes an obligatory condition for the whole chain, from production to transport, storage and even exhibition for sale, as well as from the moment of purchase by the consumer to the storage in domestic refrigerator equipment to ensure the maintenance of their original features and quality levels, retarding the process of microbiologic, enzymatic and physical chemical degradation, which without the cold chain, previously mentioned, would make the product after a determined period of time improper for consumption.

In the case of products commercialized as “ready dishes”, which are already seasoned and cooked/baked/fried, this necessity is even more necessary in order to guarantee their nutritional, hygienic and environment temperature features, thus avoiding deterioration in a short period of time.

It is known that, usually from the moment of acquisition by the consumer, he or she become responsible for the maintenance of the temperature conditions to guarantee the product quality, because during the whole operation involving production, transport, storage and marketing, it is understood that the product would be under the responsibility of able professionals, who have the necessary machines and equipment aiming at guaranteeing the maintenance of product features and quality levels.

From the moment that the consumer purchases the product, it is taken into account that the product suffers temperature variations until it reaches an environment providing minimum refrigeration, taking into consideration mainly the fact that the consumer often may not be technically able or even possess all the necessary machines, equipment and technology to maintain the product under minimum temperature conditions to guarantee the maintenance of product features and quality levels.

When opting for the purchase of the product, the customer usually removes the product from the refrigerated exhibitor where it is conditioned and transfers it to his/her purchase cart, where it will remain for some time until the consumer finalizes his/her purchases, still within the commercial establishment. After finalizing his/her purchases the customer must go through product “check-out”, to effect payment of the purchased products. Soon after payment, all the products are conditioned in bags and taken to the transport vehicle (from the customer or equivalent), which will supposedly go directly to the home or establishment of the consumer, where the product will be transferred to a refrigeration equipment of the freezing or similar type, aiming at maintaining the product frozen.

It is perceived, therefore, hypothetically that from the moment the customer decides to purchase the product and removes it from the refrigerated exhibitor, to the moment when he/she arrives home and conditions the product in his/her freezer some hours may go by, which could certainly compromise the quality of the product, without taking into consideration that the product should be maintained in the freezer for conservation and defrosted before consumption, otherwise the product, which during the whole chain of distribution had been maintained under ideal conditions of refrigeration, has its validity altered, and may even become, when opened for preparation by the consumer, improper for consumption.

Aiming only at demonstrating the great differential between the “Stroganoff” product usually found for sale and which needs the refrigeration chain and the obtaining method in question, the description of the obtaining form and marketing of a product usually found in the market (hypothetical situation) is made below:
as an example a tray of frozen “Stroganoff” usually found in the supermarkets, with an average validity of 3 months, while frozen, as follows below:
a) Under normal circumstances, for practicality, a tray of frozen “Stroganoff” is acquired, usually sold in supermarket chains;
b) It is necessary to maintain this tray under refrigeration (frozen) at a minimum temperature of −14° C., so that the product maintains (at least in part) its original properties, even knowing that the freezing simply retards the growth of microorganisms and does not inhibit their growth; this is the reason why the validity of a product with these features is approximately 3 months, counting from the manufacturing date;
c) For the preparation of the frozen Stroganoff tray, it is necessary, first, to defrost it completely, which would take from 5 to 10 minutes if a microwave oven were used, in the defrosting option (the time may vary according to the microwave power); another option would involve the maintenance of the product under natural environment conditions, out of refrigeration, for the necessary time to defrost it completely, which would usually take more than 40 minutes;
d) After defrosting, the product may then be heated, which can be done conventionally (in a normal cooking pan and taking it to the fire) or using a microwave oven.

In this way, we can conclude that it is not a completely convenient product and easy of being handled by the consumer. Another option, still often used, is the preparation of the “Stroganoff” type product every time it is necessary for consumption, and the traditional preparation of which lacks any special explanation.

In view of this reality, it was necessary to develop a method of preparation and differentiated obtaining form for the “Stroganoff” type product, the production stages of which are distinct from the traditional ones carried out, in order to guarantee its nutritional qualities, foreseeing a specific hygienic system and the product of which must be conditioned in a differentiated packing, which foresees the possibility of maintaining the original properties of the product for a long time, dispensing with a refrigeration system, both in the stage or production and during transport, storing, and as well as after the acquisition of the product by the final consumer.

### BRIEF DESCRIPTION OF THE INVENTION

In this manner, and aiming at presenting a new industrialized product to the consumer market, the applicant the present Obtaining Method of Food Article “Stroganoff” packed in a flexible Bag, for Immediate Consumption, Stable at Environment Temperature, where the obtained product, that is “Stroganoff” does not require any special care with a cold chain, and can be stored immediately after the production process at environment temperature, consequently requires no refrigerated transport to the Distribution Center and/or sales point and much less defrosting, which ends up altering nutritional qualities of the original product.

One of the advantages reached with the present method is the fact that, with the product in the establishment where it is being sold, it can be exhibited on common exhibition supports, that is, there is no need to exhibit the product in refrigerated exhibitors and when buying it, the customer can transport the product for hours or days on end in his/her vehicle, without the need to worry about the temperature, because the product, apart from needing no refrigeration, supports sudden temperature variations, with the consumer, for example, being able to store the product in remote places as a beach or farm house, as long he/he simply maintains the packing intact, that is, hermetically sealed, so that both product quality and original features will be maintained ready for consumption at any moment, immediately after heating.

It is an extremely convenient product, which can be served at any moment, without the need of any special preparation conditions and the certainty for the consumer that a product of excellent quality is being served according to his/her expectations.

Another advantage comprises the fact that the product shows its convenience even when being heated, because it can be heated in a microwave oven, if the consumer so desires, without the need to remove it from its original packing and requires no defrosting time.

This fact by itself already benefits the great majority of consumers, distributors and sales points in several aspects.

### BRIEF DESCRIPTION OF THE DRAWINGS

In order to supplement the present description in order to reach a better understanding of the features of present invention and according to a preferential practical realization, a set of drawings is enclosed to the description, where, on an exemplified non-limiting manner, the following points were represented.

FIG. 1 illustrates a representative flowchart of the obtaining method now innovated.

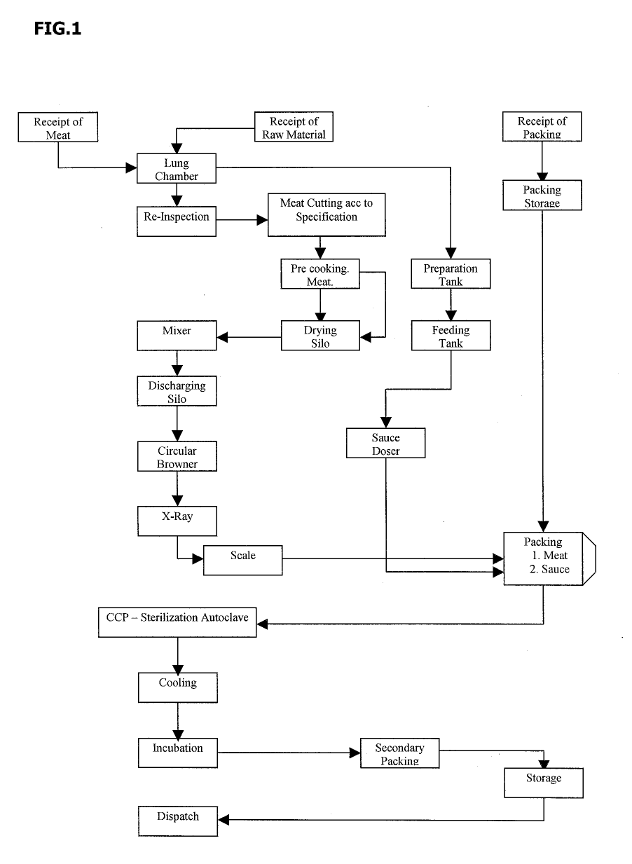

### DETAILED DESCRIPTION OF THE INVENTION

Concerning the illustrated drawings, the present invention refers to an “OBTAINING METHOD OF A FOOD ARTICLE-TYPE—STROGANOFF—IN A FLEXIBLE BAG-TYPE OR SIMILAR PACKING, FOR IMMEDIATE CONSUMPTION STABLE AT ENVIRONMENT TEMPERATURE”, food article obtaining method, particularly “Stroganoff”, which presents itself, in its final constitution, as a portion packed in a bag or pouch or similar, of the ready for consumption type, with the possibility of being conserved at environment temperature during the whole chain formed by industrial manufacturing until preparation/final consumption by the final consumer, without the need of refrigeration for transport, storage and/or exhibition for sale.

The present obtaining method of product “Stroganoff” type ready dish comprises the following stages:

I) Receipt and storing of the components integrating the “Stroganoff”-type product ready for consumption:
a) Receipt of Meat in its natural state, with the possibility to involve Cooled/Frozen Bovine Meat, Cooled/Frozen Chicken Meat, and/or Cooled/Frozen Fish Meat, in sanitary location, with temperature control, with the necessary infra-structure to carry out the complete product checking and control;
b) Receipt of Supplies: The receipt of sauces is equally carried out in aseptic environment, refrigerated with all the necessary infra-structure to carry out the receipt and control of all the raw materials according to their specifications;
c) Lung Chamber: where the products should be stored according to their specifications in a manner to maintain the stability and features of each component until the moment of preparation of the “Stroganoff”-type dish ready for consumption;

II) Water treatment used during the preparation method:
a) Water treatment: all the water used in the manufacturing process goes through a filtering process, using a sequence of next-generation filters, with the capturing source foreseeing:
   Chlorine Dosimeter: model equipped with a product peristaltic pump with a motor reducer of 45 rpm controlled by an electronic board with motor speed control, led indicating that the instrument is on and dosing, retarding timer with 0 to 3 minutes time, with the possibility of choosing the time to start with the product before or after, through a JUMPER, indicated on the board through adequate commands; the pump housings are injected with special resins, offering high resistance to the action of chemical products, temperatures, dilation and shocks, with rollers in ultra-high PP molecular weight, fixed with pins to 304 stainless steel supports.
   Filtering with polishing filter: Polypropylene filter (50-micron filtering element);
   Dechlorinating: Gr activated carbon (removal of chlorine through carbon filter)

III) Preparation of the meats:
a) Meat Cuts: occur through the transfer of bovine, chicken or fish meats received, inspected and stored in refrigerated chambers to the industrial cutting machines, made in 304 stainless steel, with sanitary finishing installed in appropriate refrigerated rooms, under strict quality control programs, where the meats are cut automatically according to the specification of each product and conveyed by sanitary belts, that is, without nay human contact, to the continuous cooking in water;
b) Previous cooking of ground meat: in this process the meats are transferred automatically through conveyors from industrial cutting machines of the meats to the continuous cookers, also dispensing with human contact.
   b1) After the cut, the process is continuous feeding to the cookers;
   b2) The meats already cut receive a previous cooking in treated water for a minimum time, which varies from 5 to 10 minutes, according to the meat to be used, at the temperature of water boiling;
   b3) The temperature of water boiling (100° C.) is monitored every hour;
c) Drying Silo: After cooking, the cut and cooked meats are transferred by the continuous worm shaft system to the drying silo where the excess of temperature will be quickly removed, reducing the humidity of the product;
d) Mixer: after removal of the excess of temperature and humidity, the product is transferred by gravity, through automatic doors to the sauce mixer with all its variables (rotation direction, speed, etc.) controlled by a CPU, for a perfect homogenization of the product; like all the other equipment, both the silo and the mixer are made of 304 stainless steel with sanitary finishing especially made out for this purpose.
   d1) In the mixer, the pre-cooked cut meat is added, cooled and with a level of humidity within specifications, along with all the remaining ingredients, a mixture being arranged in the adequate time, speed and rotation. These ingredients must be mixed one by one, for a uniform mixture to the others, apart from which, being added in the indicated order, the natural acidity of each ingredient ends up breaking in the browning chain, guaranteeing its nutritional features as well as its natural stability after being conditioned to the adequate packing for that purpose. The order of the ingredients is: pre-cooked Bovine Meat, Chicken Meat, or Fish Meat, salt, mushrooms;
   d2) After the mixture of the meats with the remaining ingredients, the product is transferred to a discharge silo through a side exit, which doses the quantity/transfer time of this product, so that the integrity of the meat fibers is maintained;
e) Discharging Silo: comprises an equipment with the purpose to receive the pre-cooked and seasoned meats of the mixer and transfer them through the worm shaft system to the Circular Browner in exact quantities to guarantee the product nutritional quality, as well as the acidity exhaustion of the ingredients;
f) Circular Browner: where the cut, pre-cooked and seasoned meats are transferred through worm shafts to the circular browner, where the meat will be browned, within a rotating cylinder, also made of 304 stainless steel, remaining exposed to a system of batteries of infrared light, driven by a CPU, responsible for the control of all its variables (intensity of light, air admission, exhaustion, cylinder rotation speed, among others) accompanied by sequential command of air jets, to keep the meats from sticking to the cylinder walls during the process, obtaining a uniform browning without the need of using oils or fats, also especially constructed for this purpose;
g) X-Ray: After the meats are browned in the Circular Browner, as above mentioned, they follow through conveyor belts to a non-radioactive detection system to identify possible strange objects, which may be together with the pre-cooked, seasoned and browned meats, such as metal, bones, plastic, etc.;
h) Electronic scales for the ground meat: after passing by the detection system, the meats follow to an electronic weighing system, comprising a sequence of stages with the purpose to condition the correct quantity of meat within each pouch-type flexible packing.

IV) Preparation of the Sauce to be incorporated to the meat:
a) Sauce preparation tank: the preparation of the sauce requires adding of the ingredients in the indicated order, aiming at reducing their acidity and allowing the adequate homogeneity. The filtered water has to be always in the iced state and is conditioned in the sauce preparation tanks in adequate quantity as described in the technical sheet of the sauce preparation, with this equipment maintaining the refrigeration process within its structure and keeping the water at low temperatures in its interior; the ingredients are then conditioned for dissolution of the sauce, which, through high rotation agitators remain moving until the complete homogenization of the product. The order of the ingredients is: powder milk cream, modified amid, salt, tomato powder, sugar, onion powder, garlic powder, malt dextrin, meat extract, sauces, vegetal fat, aromatizers, emulsifiers, citric acid.
b) Feeding tank: after its preparation, the sauce is transferred through the pumps to the feeding tanks where the sauce remains at low temperature in constant movement awaiting its transfer to the dosimeters;
c) Sauce Dosimeter: the sauce dosimeters receive it according to necessity, through the feeding pumps equipped with volume dosing jets, which allow the correct volume and quantity transfer of sauce from the Feeding Tank to the bags where the meats are already conditioned;

V) Packing stages:
a) Vacuum packing machines: after the conditioning the correct quantity of pre-cooked, seasoned and browned meat, as well as the correct dosing of sauce in the plastic bags, the packing machine removes the oxygen existent in these bags and immediately proceeds to sealing them, making them hermetically sealed, ready to be sterilized;
b) Sterilization: after being hermetically sealed, the packing is forwarded for the process of sterilization in autoclaves; already in the interior of the autoclaves, the products are submitted to a thermal treatment process through the elevation of temperature, making the temperature in the interior of the packing reach a minimum of 121.5° C. for 15 minutes; this temperature is sufficient for product sterilization, eliminating all microorganisms alive within the packing; as the packing is hermetically sealed, with the plastic material having several layers with a highly elevated barrier to oxygen, thus avoiding the passage of oxygen to the interior of the packing, it can be confirmed that that product will remain sterilized, maintaining a stable environment temperature without the need of refrigeration to maintain its properties and original features; still in the autoclaves several instruments are installed with the purpose to guarantee the efficiency of the equipment, such as:
Mercury Thermometer—calibrated every six months with a standard instrument tracked to the RBC—Time and Temperature Recorder;
Manometer—Calibrated every six months with a standard instrument tracked to the RBC—Time and Temperature Recorder;
c) Cooling and Incubation: after sterilization the packing must be quickly cooled in chlorinated water (5 ppm) until they reach the temperature of 35° C., so as to retain sufficient heat to dry them up; after cooling, one unit per batch of 1000 units is collected and incubated in a room with a temperature variation from 34° C. to 38° C. during a minimum period of 10 days, with the purpose to stimulate the growth of microorganisms which can, if any failure occurred in the process, eventually be present in the product; still during the incubation process several microbiological analyses are carried out in the product, in order to guarantee that it is in fact sterilized and safe for human consumption; the execution of these analyses obeys official sampling procedures;
d) Secondary packing room: After sterilization, cooling and incubation, the product needs no more special care, and can be conditioned in boxes and displays, for transport and marketing. This process is carried out in the secondary packing rooms, which are maintained at environment temperature. Secondary packing is duly identified, containing production batch, date of validity, among others going through a process of visual checking and also labeling, cleaning, with observations duly recorded.

1. “Obtaining method of a food article-type—Stroganoff—in a flexible bag-type or similar packing, for immediate consumption stable at environment temperature”, food article obtaining method, particularly “Stroganoff”, which presents itself, in its final constitution, as a portion packed in a bag or pouch or similar, of the ready for consumption type, characterized by the fact that the method comprises the following stages:
I) Receipt and storing of the components integrating the “Stroganoff”-type product ready for consumption:
a) Receipt of Meat in its natural state, with the possibility to involve Cooled/Frozen Bovine Meat, Cooled/Frozen Chicken Meat, and/or Cooled/Frozen Fish Meat, in sanitary location, with temperature control, with the necessary infra-structure to carry out the complete product checking and control;
b) Receipt of Supplies: The receipt of spices is equally carried out in aseptic environment, refrigerated with all the necessary infra-structure to carry out the receipt and control of all the raw materials according to their specifications;
c) Lung Chamber: where the products should be stored according to their specifications in a manner to maintain the stability and features of each component until the moment of preparation of the “Stroganoff”-type dish ready for consumption;
II) Water treatment used during the preparation method:
a) Water treatment: all the water used in the manufacturing process goes through a filtering process, using a sequence of next-generation filters, with the capturing source foreseeing:
Chlorine Dosimeter: model equipped with a product peristaltic pump with a motor reducer of 45 rpm controlled by an electronic board with motor speed control, led indicating that the instrument is on and dosing, retarding timer with 0 to 3 minutes time, with the possibility of choosing the time to start with the product before or after, through a JUMPER, indicated on the board through adequate commands; the pump housings are injected with special resins, offering high resistance to the action of chemical products, temperatures, dilation and shocks, with rollers in ultra-high PP molecular weight, fixed with pins to 304 stainless steel supports.
Filtering with polishing filter: Polypropylene filter (50-micron filtering element);
Dechlorinating: Gr activated carbon (removal of chlorine through carbon filter)
III) Preparation of the meats:
a) Meat Cuts: occur through the transfer of bovine, chicken or fish meats received, inspected and stored in refrigerated chambers to the industrial cutting machines, made in 304 stainless steel, with sanitary finishing installed in appropriate refrigerated rooms, under strict quality control programs, where the meats are cut automatically according to the specification of each product and conveyed by sanitary belts, that is, without nay human contact, to the continuous cooking in water;
b) Previous cooking of ground meat: in this process the meats are transferred automatically through conveyors from industrial cutting machines of the meats to the continuous cookers, also dispensing with human contact.
b1) After the cut, the process is continuous feeding to the cookers;
b2) The meats already cut receive a previous cooking in treated water for a minimum time, which varies from 5 to 10 minutes, according to the meat to be used, at the temperature of water boiling;
b3) The temperature of water boiling (100° C.) is monitored every hour;
c) Drying Silo: After cooking, the cut and cooked meats are transferred by the continuous worm shaft system to the drying silo where the excess of temperature will be quickly removed, reducing the humidity of the product;
d) Mixer: after removal of the excess of temperature and humidity, the product is transferred by gravity, through automatic doors to the spice mixer with all its variables (rotation direction, speed, etc.) controlled by a CPU, for a perfect homogenization of the product; like all the other equipment, both the silo and the mixer are made of 304 stainless steel with sanitary finishing especially made out for this purpose.
d1) In the mixer, the pre-cooked cut meat is added, cooled and with a level of humidity within specifications, along with all the remaining ingredients, a mixture being arranged in the adequate time, speed and rotation. These ingredients must be mixed one by one, for a uniform mixture to the others, apart from which, being added in the indicated order, the natural acidity of each ingredient ends up breaking in the browning chain, guaranteeing its nutritional features as well as its natural stability after being conditioned to the adequate packing for that purpose. The order of the ingredients is: pre-cooked Bovine Meat, Chicken Meat, or Fish Meat, salt, mushrooms;
d2) After the mixture of the meats with the remaining ingredients, the product is transferred to a discharge silo through a side exit, which doses the quantity/transfer time of this product, so that the integrity of the meat fibers is maintained;
e) Discharging Silo: comprises an equipment with the purpose to receive the pre-cooked and seasoned meats of the mixer and transfer them through the worm shaft system to the Circular Browner in exact quantities to guarantee the product nutritional quality, as well as the acidity exhaustion of the ingredients;
f) Circular Browner: where the cut, pre-cooked and seasoned meats are transferred through worm shafts to the circular browner, where the meat will be browned, within a rotating cylinder, also made of 304 stainless steel, remaining exposed to a system of batteries of infrared light, driven by a CPU, responsible for the control of all its variables (intensity of light, air admission, exhaustion, cylinder rotation speed, among others) accompanied by sequential command of air jets, to keep the meats from sticking to the cylinder walls during the process, obtaining a uniform browning without the need of using oils or fats, also especially constructed for this purpose;
g) X-Ray: After the meats are browned in the Circular Browner, as above mentioned, they follow through conveyor belts to a non-radioactive detection system to identify possible strange objects, which may be together with the pre-cooked, seasoned and browned meats, such as metal, bones, plastic, etc.;
h) Electronic scales for the ground meat: after passing by the detection system, the meats follow to an electronic weighing system, comprising a sequence of stages with the purpose to condition the correct quantity of meat within each pouch-type flexible packing.
IV) Preparation of the Sauce to be incorporated to the meat:
a) Sauce preparation tank: the preparation of the sauce requires adding of the ingredients in the indicated order, aiming at reducing their acidity and allowing the adequate homogeneity. The filtered water has to be always in the iced state and is conditioned in the sauce preparation tanks in adequate quantity as described in the technical sheet of the sauce preparation, with this equipment maintaining the refrigeration process within its structure and keeping the water at low temperatures in its interior; the ingredients are then conditioned for dissolution of the sauce, which, through high rotation agitators remain moving until the complete homogenization of the product. The order of the ingredients is: powder milk cream, modified amid, salt, tomato powder, sugar, onion powder, garlic powder, malt dextrin, meat extract, spices, vegetal fat, aromatizers, emulsifiers, citric acid.
b) Feeding tank: after its preparation, the sauce is transferred through the pumps to the feeding tanks where the sauce remains at low temperature in constant movement awaiting its transfer to the dosimeters;
c) Sauce Dosimeter: the sauce dosimeters receive it according to necessity, through the feeding pumps equipped with volume dosing jets, which allow the correct volume and quantity transfer of sauce from the Feeding Tank to the bags where the meats are already conditioned;
V) Packing stages:
a) Vacuum packing machines: after the conditioning the correct quantity of pre-cooked, seasoned and browned meat, as well as the correct dosing of sauce in the plastic bags, the packing machine removes the oxygen existent in these bags and immediately proceeds to sealing them, making them hermetically sealed, ready to be sterilized;
b) Sterilization: after being hermetically sealed, the packing is forwarded for the process of sterilization in autoclaves; already in the interior of the autoclaves, the products are submitted to a thermal treatment process through the elevation of temperature, making the temperature in the interior of the packing reach a minimum of 121.5° C. for 15 minutes; this temperature is sufficient for product sterilization, eliminating all microorganisms alive within the packing; as the packing is hermetically sealed, with the plastic material having several layers with a highly elevated barrier to oxygen, thus avoiding the passage of oxygen to the interior of the packing, it can be confirmed that that product will remain sterilized, maintaining a stable environment temperature without the need of refrigeration to maintain its properties and original features; still in the autoclaves several instruments are installed with the purpose to guarantee the efficiency of the equipment, such as:
Mercury Thermometer—calibrated every six months with a standard instrument tracked to the RBC—Time and Temperature Recorder;
Manometer—Calibrated every six months with a standard instrument tracked to the RBC—Time and Temperature Recorder;
c) Cooling and Incubation: after sterilization the packing must be quickly cooled in chlorinated water (5 ppm) until they reach the temperature of 35° C., so as to retain sufficient heat to dry them up; after cooling, one unit per batch of 1000 units is collected and incubated in a room with a temperature variation from 34° C. to 38° C. during a minimum period of 10 days, with the purpose to stimulate the growth of microorganisms which can, if any failure occurred in the process, eventually be present in the product; still during the incubation process several microbiological analyses are carried out in the product, in order to guarantee that it is in fact sterilized and safe for human consumption; the execution of these analyses obeys official sampling procedures;
d) Secondary packing room: After sterilization, cooling and incubation, the product needs no more special care, and can be conditioned in boxes and displays, for transport and marketing. This process is carried out in the secondary packing rooms, which are maintained at environment temperature. Secondary packing is duly identified, containing production batch, date of validity, among others going through a process of visual checking and also labeling, cleaning, with observations duly recorded.

2. “Obtaining Method”, according to claim 1, characterized by the fact that the “Stroganoff”-type product ready for consumption is packed in a bag- or pouch-type or similar packing.

3. “Obtaining Method”, according to claims 1 and 2, characterized by the fact that the “Stroganoff”-type product ready for consumption is maintained conserved stable at environment temperature during the whole chain formed by industrial production until preparation/consumption by the final consumer, dispensing with refrigeration for its conservation during transport, storage and/or exhibition for sale.
